(19) United States
(12) Patent Application Publication
(10) Pub. No.: US 2025/0121540 A1
(43) Pub. Date: Apr. 17, 2025

(54) METHOD FOR CLEANING A MOLDING INSERT

(71) Applicant: Alcon Inc., Fribourg (CH)

(72) Inventors: Giovanni Campanelli, Grosswallstadt (DE); Thorsten Repp, Obernburg (DE); Felix Zimmermann, Eschau (DE); Muhammad Rushdi Mohamad, Aschaffenburg (DE); Torsten Richter, Grosswallstadt (DE)

(21) Appl. No.: 18/915,548

(22) Filed: Oct. 15, 2024

Related U.S. Application Data
(60) Provisional application No. 63/590,932, filed on Oct. 17, 2023.

(51) Int. Cl. B29C 45/17; B08B 15/04; B24C 1/00; B29C 31/00; B29C 45/14; B29D 11/00; B29L 11/00

(52) U.S. Cl. CPC B29C 45/1753; B08B 15/04; B24C 1/003; B29C 31/008; B29D 11/00125; B29C 2045/14868; B29L 2011/0041

(57) ABSTRACT

A method for cleaning a molding insert for injection-molding of single-use ophthalmic lens molds comprises the steps of providing an insert holder and a molding surface of the molding insert faces away from the insert holder. A dry ice nozzle comprises an inlet for the supply of dry ice, a nozzle channel comprising a longitudinally extending diverging inner wall portion terminating in an outlet opening of the nozzle channel, and a nozzle housing with a circumferentially running distal end wall. The nozzle housing further comprises a housing wall portion extending away from the distal end wall to define an exhaust channel. The method further comprises positioning the dry ice nozzle on the insert holder, supplying dry ice particles to the nozzle inlet to generate a jet of dry ice particles impinging on the molding surface of the molding insert, and removing exhaust gases.

### FIELD OF THE INVENTION

The present invention generally relates to the field of manufacturing ophthalmic lens molds, in particular single-use lens molds for use in manufacturing contact lenses such as soft contact lenses, for example silicon hydrogel contact lenses. More specifically, it is related to a method for cleaning a molding insert for injection-molding of single-use ophthalmic lens molds.

### BACKGROUND OF THE INVENTION

Mass production of ophthalmic lenses, in particular contact lenses such as soft contact lenses, for example silicon hydrogel contact lenses, is typically performed using lens-molding processes. In a lens-molding process a lens-forming material, for example a polymer or pre-polymer solution, may be introduced into a female lens mold which is closed by a corresponding male lens mold and is subsequently cured to form an ophthalmic lens. The lens molds used in such lens-molding processes are either for single-use or are re-usable.

Re-usable lens molds are typically glass molds and are expensive (this is why they are re-used a large number of times), whereas single-use lens molds are cheap plastic molds which are normally manufactured using injection-molding apparatuses. In an injection-molding apparatus, a flowable material, typically a polyolefin such as polypropylene, is injected into cavities formed between tooling plates of the injection-molding molding apparatus at high temperature and high pressure. These cavities define the shape of the lens molds to be formed. After injection, the flowable material rapidly cools down to a solid state to form the lens mold. The tooling plates of the injection-molding apparatus are then moved away from each other whereupon the lens molds are removed from the tooling plates for subsequent use in the manufacture of ophthalmic lenses.

Injection-molded plastic lens molds typically have a front surface comprising a lens-forming surface (male or female) of optical quality defining either the anterior or the posterior surface of the lens, and a back surface comprising a surface located opposite to the lens-forming surface. The cavities defining the shape of the lens molds are typically formed with the aid of molding inserts, made for example from aluminum, mounted to the tooling plates of the injection-molding apparatus. These molding inserts define the shape of the lens-forming surface and of the back surface opposite thereto. Accordingly, that molding insert defining the shape of the lens-forming surface must have a molding surface of optical quality in order to be able to form the corresponding lens-forming surface, whereas that molding insert defining the shape of the surface located opposite to the lens-forming surface must have a surface of the quality specified for this opposite surface. To ensure a consistent quality of the injection-molded lens molds, it is crucial that the molding surfaces, in particular the molding surface of optical quality, are clean and keep their geometry during the injection-molding of a large number of lens molds.

After a large number of lens molds have been injection-molded, residues of the flowable material, for example a polyolefin, such as polypropylene, may adhere to the molding inserts, in particular to the molding surface and may possibly affect the quality of the injection-molded lens molds. These residues need to be removed from the molding insert, in particular from the molding surface, without affecting the geometry of the molding surface and without affecting or damaging the molding surface.

Cleaning may be performed manually using bristle brushes. However, this (mechanical) cleaning method is prone to producing scratches on the molding surfaces, in particular on the molding surface of optical quality, and such scratches need to be avoided. Moreover, this cleaning operation needs to be performed with great care and is thus relatively time-consuming as the time required to clean one single molding insert may be up to 5 minutes and thus requires a considerable amount of manpower, in particular as typically a plurality of such molding inserts need to be cleaned. In addition, as the manual cleaning with bristle brushes is performed by human operators, the result may lack consistency in the degree of cleanliness.

It is therefore an object of the invention to overcome the afore-mentioned disadvantages and to suggest an appropriate method to minimize the risk of scratches on the molding surface, in particular the surface of optical quality, and to avoid inconsistencies in the results of the cleaning process as well as an undue consumption of time and manpower.

### SUMMARY OF THE INVENTION

In accordance with the present invention, these and other objects are met by a method for cleaning a molding insert for injection-molding of a single-use ophthalmic lens mold, as specified by the features of the independent claim. Advantageous aspects of the method according to the invention are the subject of the dependent claims.

As used in the specification including the appended claims, the singular forms “a”, “an”, and “the” include the plural, unless the context explicitly dictates otherwise. When using the term “about” with reference to a particular numerical value or a range of values, this is to be understood in the sense that the particular numerical value referred to in connection with the “about” is included and explicitly disclosed, unless the context clearly dictates otherwise. For example, if a range of “about” numerical value A to “about” numerical value B is disclosed, this is to be understood to include and explicitly disclose a range of numerical value A to numerical value B. Also, whenever features are combined with the term “or”, the term “or” is to be understood to also include “and” unless it is evident from the specification that the term “or” must be understood as being exclusive.

According to the invention, a method for cleaning a molding insert for injection-molding of a single-use ophthalmic lens mold is suggested. The method comprises the steps of
providing an insert holder comprising a holder abutment surface,
arranging the molding insert on the insert holder such that a molding surface of the molding insert faces away from the insert holder,
providing a dry ice nozzle comprising
   an inlet for the supply of dry ice particles,
   a nozzle channel fluidically connected to the nozzle inlet, the nozzle channel comprising a longitudinally extending inner wall portion diverging towards and terminating at a distal end of the inner wall portion in an outlet opening of the nozzle channel, the diameter of the outlet opening of the nozzle channel being at least as large as the diameter of the molding surface of the molding insert, and
   a nozzle housing comprising
      a circumferentially running distal end wall comprising a nozzle abutment surface which is arranged distally to the outlet opening of the nozzle channel to define a gap between the distal end wall and the outlet opening of the nozzle channel, the distal end wall defining a housing opening having a diameter which is at least as large as the diameter of the molding insert, and
         a housing wall portion extending away from the distal end wall and surrounding the longitudinally extending nozzle channel to define an exhaust channel which is fluidically connected to the gap and to at least one exhaust opening arranged in the housing wall portion to allow for the removal of exhaust gas.

The method further comprises the steps of
positioning the dry ice nozzle on the insert holder such that the nozzle abutment surface abuts against the holder abutment surface,
supplying dry ice particles to the nozzle inlet to generate a jet of dry ice particles impinging on the molding surface of the molding insert through the nozzle channel and the outlet opening of the nozzle channel, and
removing exhaust gases and any solid material removed from the molding surface of the molding insert through the exhaust channel and the at least one exhaust opening arranged in the housing wall portion of the nozzle housing.

According to one aspect of the method according to the invention, the nozzle channel is rotationally symmetric with respect to a longitudinal channel axis and has a diameter that increases from a diameter in the range of 5 millimeters to 10 millimeters, in particular 6 millimeters to 8 millimeters, at a proximal end of the diverging inner wall portion to a diameter in the range of 19 millimeters to 25 millimeters, in particular 21 millimeters to 23 millimeters, at the distal end of the diverging inner wall portion along a length of the diverging inner wall portion in the range of 31 millimeters to 96 millimeters, in particular in 50 millimeters to 70 millimeters.

According to another aspect of the method according to the invention, the diverging inner wall portion of the nozzle channel has an opening angle in the range of 4 degrees to 15 degrees, in particular 4 degrees to 7.25 degrees, with respect to a longitudinal channel axis.

According to yet another aspect of the method according to the invention, the step of providing a nozzle comprises providing a nozzle with the gap between the circumferentially running distal end wall and the outlet opening of the nozzle channel having a gap width in longitudinal direction in the range of 7 millimeters to 15 millimeters, in particular 10 millimeters to 12 millimeters.

According to a further aspect of the method according to the invention, the exhaust channel circumferentially surrounds the longitudinally extending nozzle channel between the nozzle channel and the housing wall portion of the nozzle housing that extends away from the distal end wall.

According to yet a further aspect of the method according to the invention, the at least one exhaust opening arranged in the housing wall portion comprises one to six, in particular one, exhaust openings arranged in the housing wall portion. Each of the exhaust openings has a diameter in the range of 10 millimeters to 60 millimeters, in particular 40 millimeters to 45 millimeters.

According to another aspect of the method according to the invention, the nozzle channel comprises a further longitudinally extending inner wall portion which is fluidically connected to the nozzle inlet and which converges from a proximal end thereof towards a throat at a distal end thereof, with the diverging inner wall portion of the nozzle channel being fluidically connected to the throat.

According to yet another aspect of the method according to the invention, the molding insert is a molding insert selected from a group of molding inserts having one of
a convex molding surface for forming an optical surface of a female lens mold,
a concave molding surface for forming an optical surface of a male lens mold,
a concave molding surface for forming a back surface of a female lens mold, the back surface of the female lens mold located opposite to an optical surface of the female lens mold, or
a convex molding surface to form a back surface of a male lens mold, the back surface of the male lens mold located opposite to an optical surface of the male lens mold.

According to a further aspect of the method according to the invention, the step of supplying dry ice particles to the nozzle inlet comprises supplying dry ice particles having an average particle size in a range of 20 micrometers to 100 micrometers, in particular 40 micrometers to 80 micrometers, at a pressure in a range of 2 bars to 8 bars, in particular 4 bars to 6 bars, for a duration in a range of 10 seconds to 50 seconds, in particular 20 seconds to 40 seconds, and with a throughput of dry ice particles in a range of 1 gram to 3 grams per second.

According to yet a further aspect of the method according to the invention, the step of removing exhaust gases and any solid material removed from the molding surface of the molding insert comprises removing solid material used in injection-molding the single-use ophthalmic lens molds, in particular a polyolefin such as polypropylene.

The method according to the invention is advantageous in that the result of the cleaning process is considerably more consistent compared to mechanical cleaning with bristle-brushes performed by operators. It allows for cleaning the molding surface of the molding insert under predetermined and reproducible conditions, such that the cleaning surface of ach molding insert is consistently cleaned in the same manner. The nozzle abutment surface and the holder abutment surface may be configured such that the dry ice nozzle (in the following only denoted ‘nozzle’) may always be positioned in the same position relative to the molding insert. The molding insert may be mounted at a predetermined location on the insert holder. For this purpose the insert holder may comprise a bore to receive a mounting pin of the molding insert which is arranged opposite to the molding surface of the molding insert, so that the respective molding insert to be cleaned can always be mounted at the same predetermined location on the insert holder relative to the holder abutment surface, with the molding surface to be cleaned facing away from the insert holder (and away from the abutment surface). Thus, the nozzle (and also the nozzle channel) can always be positioned in a reproducible spatial arrangement relative to the molding surface of the molding insert, with the molding surface facing the outlet opening of the nozzle channel, such that a jet of dry ice particles exiting the outlet opening of the nozzle channel impinges on the molding surface from a predetermined and reproducible distance and in a predetermined and reproducible direction. For example, the nozzle may be positioned relative to the molding surface of the molding insert such that a propagation direction of a central portion of the jet of dry ice particles is normal to a tangential plane at the apex of the molding surface of the molding insert. Moreover, the nozzle and the insert holder may be configured such that the outlet opening of the nozzle channel is centered with respect to the molding surface of the molding insert to make sure the molding surface is entirely arranged within the jet of dry ice particles exiting the outlet opening of the nozzle channel, and that a central portion of the jet of dry ice particles impinges centrally on the molding surface of the molding insert at the apex of the molding surface.

The parameters relevant for the cleaning process such as size, density and velocity distribution of the dry ice particles in the jet can be controlled in a reproducible manner to make sure each insert is not only arranged in the same position relative to the nozzle and the outlet opening of the nozzle channel, but is also impinged by a jet of dry ice particles having the same jet characteristics. For example, the dry ice particles having a predetermined average size may be generated by a commercially available dry ice machine and mixed with a pressurized gas (such as pressurized air having a predetermined pressure). This mixture of pressurized gas and dry ice particles may be supplied to the nozzle inlet. As the nozzle geometry is given and does not vary, the aforementioned relevant parameters can be reproducibly controlled by the pressure of the pressurized gas and the settings of the dry ice machine. Thus, the method according to the invention allows to provide a jet of dry ice particles having a consistent particle size, density and velocity distribution for each molding surface of each molding insert to be cleaned.

In addition, the duration of application of the jet of dry ice particles to the molding surface of the molding insert can be controlled by the duration the dry ice particles are supplied to the nozzle inlet. This duration is typically significantly less than one minute, for example it may be in a range of 10 seconds to 50 seconds, in particular 20 seconds to 40 seconds. In one embodiment, the duration may be 30 seconds. This is only a fraction of the time of typically five minutes needed to manually and mechanically clean the molding insert by an operator using a bristle brush and is thus much more efficient (in addition to the advantages regarding the uniform cleaning process conditions). Thus, the cleaning method according to the invention also considerably reduces the time needed to clean the molding insert, which is advantageous inasmuch as typically a plurality of molding inserts needs to be cleaned.

In addition, the risk of producing scratches on the molding surface caused by the cleaning process is essentially eliminated. The method according to the invention uses dry ice blasting which essentially is based on cooling the residues of material adhered to the insert, abrasive effects due to the impact of the dry ice particles and sublimation of the dry ice particles and the associated increase in volume. It is not based on any mechanical brushing action, and therefore the risk to produce scratches on the molding surface of the molding insert is essentially zero. In addition, the cleaning method of the instant invention does not affect the geometry of the molding insert and its molding surface.

Removal of the exhaust gases and any solid material through the exhaust channel and the at least one exhaust opening of the nozzle housing allows for a safe and controlled removal of the exhaust gas comprising carbon dioxide as well as any solid material that is removed from the molding surface. Thereby, it can be avoided that carbon dioxide gas in the ambient air may increase to a level that could give rise to health concerns of the operators working in the room where cleaning is performed.

The exhaust channel which is fluidically connected to the gap between the distal end wall of the nozzle housing and the outlet opening of the nozzle channel allows for a uniform removal of the exhaust gas and the solid material in all azimuthal directions relative to the longitudinal direction, such that asymmetric pressure and flow distributions are avoided.

A rotational symmetry of the nozzle geometry is advantageous in that it enables the formation of a jet of dry ice particles having a rotationally symmetrical geometry with respect to the longitudinal channel axis of the nozzle channel. This is particularly advantageous for molding inserts which are used in injection-molding of ophthalmic lens molds, as the molding surfaces of these molding inserts and typically also the molding inserts as a whole have a circular circumference. A jet of dry ice particles that has a rotationally symmetrical geometry is therefore advantageous as the entire molding surface can be efficiently covered by the jet of dry ice particles.

The specified range for the diameter of the nozzle channel in the diverging inner wall portion is advantageous for cleaning molding inserts as they allow the formation of a jet of dry ice particles that is particularly suitable for cleaning molding inserts for injection-molding single-use ophthalmic lens molds. The diameter of the outlet opening of the nozzle channel at the distal end of the diverging inner wall portion is chosen such as to efficiently cover the molding surface of a molding insert used in injection-molding of single-use ophthalmic lens molds.

The specified range for the opening angle of the diverging inner wall portion of the nozzle channel with respect to the longitudinal channel axis allows to form a jet of dry ice particles having the desired jet characteristics such as density and velocity distribution of the dry ice particles as well as the desired jet diameter at the outlet opening of the nozzle channel to cover the entire molding surface of the molding insert. Moreover, the specified range for the (acute) opening angle allows for a smooth flow of the jet along the diverging inner wall portion.

The specified range for the gap width allows for an efficient removal of the exhaust gas and any solid material removed from the molding surface of the molding insert and at the same time allows to position the outlet opening of the nozzle channel at a desired distance from an apex of the molding surface to achieve the consistent cleaning of the molding surface.

Having the exhaust channel circumferentially surround the longitudinally extending nozzle channel between the (outer wall of the) nozzle channel and the (inner wall of the) housing wall portion of the nozzle housing that extends away from the distal end wall allows for an efficient removal of the exhaust gases and any solid material removed from the molding surface of the molding insert through the exhaust channel and the one or more exhaust openings arranged in the said housing wall portion. It also allows for a compact design of the nozzle housing (and thus of the nozzle as a whole).

A number of one to six, in particular one, such exhaust openings in the housing wall portion, each of which has a diameter in the range of 10 millimeters to 60 millimeters, in particular 40 millimeters to 45 millimeters, allows for an efficient removal of the exhaust gases and any solid material removed from the molding surface through the said exhaust openings. Moreover, the exhaust openings may for example be arranged symmetrically with respect to the longitudinal channel axis. The exhaust openings may be connected to a closed exhaust system, such that the exhaust gases are prevented from entering the ambient. Thereby, a possible health risk for the operators working in the room where the cleaning process is performed (increased level of carbon dioxide contained in the ambient) may be prevented. In addition, suction may be applied to the exhaust openings which may further improve the efficient removal of exhaust gas and solid material removed from the molding surface.

As regards the nozzle channel, the nozzle channel may comprise a further longitudinally extending inner wall portion fluidically connected to the nozzle inlet and converging from a proximal end of this further inner wall portion towards a throat at a distal end of the converging inner wall portion. This may be advantageous as it allows for accelerating the dry ice particles during formation of the jet in the nozzle channel.

By way of example, the molding inserts may be made of aluminum, but generally the cleaning method of the invention is not limited to the use of any material the molding inserts are made of. Also, the cleaning method according to the invention is applicable to the various different types of molding inserts (concave and convex, either for forming optical surfaces or back surfaces of the ophthalmic lens molds). These different types of molding inserts can all be cleaned using the method according to the invention. And although the avoidance of scratches on the molding surfaces is one of the advantages that renders the cleaning method of the invention particularly applicable for molding inserts which are used in the formation of the optical surfaces of the ophthalmic lens molds, it is useful as well for the cleaning of molding inserts which are used in the formation of the back surfaces of the ophthalmic lens molds, so that only one nozzle design can be used for all types of molding inserts.

The specified ranges for the parameters of the method according to the invention, i.e. average particle size, pressure, duration and throughput of dry ice particles are particularly advantageous for cleaning of molding inserts for injection-molding of single-use ophthalmic lens molds. In addition, they are particularly advantageous in combination with a nozzle channel having the specified ranges for the geometrical parameters of the diverging inner wall portion of the nozzle channel.

As already mentioned, the cleaning method of the instant invention is particularly suitable for cleaning molding surfaces of molding inserts which are used in injection-molding of single use ophthalmic lens molds. Such lens molds are typically made of plastics, and polyolefins, in particular polypropylene, are typical materials of choice for such single-use lens molds.

### BRIEF DESCRIPTION OF THE DRAWINGS

Further advantageous aspects of the invention become apparent from the following description of embodiments of the invention with the aid of the (schematic) drawings, in which:

FIG. 1 shows an embodiment of a nozzle for use in the method according to the invention,

FIG. 2 shows a first embodiment illustrating the method according to the invention, in a set-up where the molding surface of the molding insert is a convex molding surface;

FIG. 3 shows a second embodiment illustrating the method according to the invention, in a set-up where the molding surface of the molding insert is a concave molding surface.

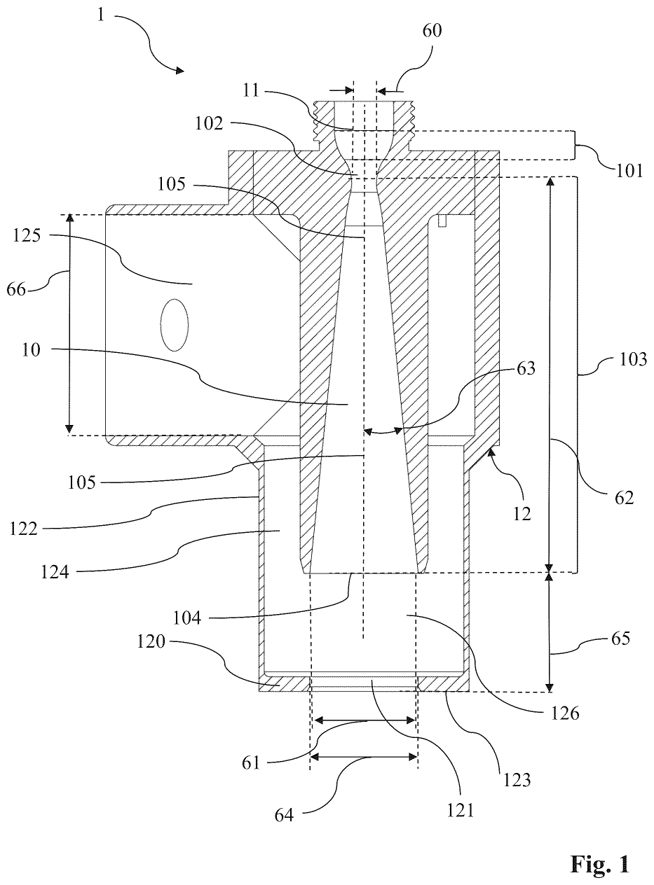

FIG. 1 shows an embodiment of a dry ice nozzle 1 (in the following only denoted (‘nozzle’) for use in the method according to the invention. Nozzle 1 comprises an inlet 11 for the supply of dry ice particles. Nozzle 1 further comprises a nozzle channel 10 which is rotationally symmetric (with regard to the geometry) with respect to a longitudinal channel axis 105 of nozzle channel 10. Nozzle channel 10 is fluidically connected to inlet 11 of nozzle 1. Nozzle channel 10 comprises a longitudinally extending inner wall portion 103 that diverges towards and terminates at a distal end of diverging inner wall portion 103 in an outlet opening 104 of nozzle channel 10. In the diverging inner wall portion 103, a diameter of the nozzle channel 10 increases from a diameter 60 in the range of 5 millimeters to 10 millimeters, in particular 6 millimeters to 8 millimeters, at a proximal end of the diverging inner wall portion 103 to a diameter 61 (corresponding to the diameter of outlet opening 104) in the range of 19 millimeters to 25 millimeters, in particular 21 millimeters to 23 millimeters, at the distal end of the diverging inner wall portion 103 along a length 63 of the diverging inner wall portion 103 in the range of 31 millimeters to 96 millimeters, in particular 50 millimeters to 70 millimeters. The diverging inner wall portion 103 of nozzle channel 10 has an opening angle 63 with respect to a longitudinal axis 105 of the nozzle channel 10 in the range of 4 degrees to 15 degrees, in particular 4 degrees to 7.25 degrees. Nozzle channel 10 comprises a further longitudinally extending inner wall portion 101 which is fluidically connected to nozzle inlet 11 and which converges towards a throat 102 at a distal end that further inner wall portion 101. The diverging inner wall portion 103 is fluidically connected to throat 102.

Nozzle 1 further comprises a nozzle housing 12 with a circumferentially running distal end wall 120 that comprises a nozzle abutment surface 123. A gap 126 is defined between distal end wall 120 and outlet opening 104 of nozzle channel 10. Gap 126 runs along the entire circumference of outlet opening 104 and has a gap width 65 (in the direction of longitudinal channel axis 105) that is in the range of 7 millimeters to 15 millimeters, in particular 10 millimeters to 12 millimeters. Distal end wall 120 of nozzle housing 12 defines a circularly shaped housing opening 121 having a diameter 64 which is at least as large as the diameter of the molding surface of a molding insert to be cleaned (not shown in FIG. 1), and more preferably at least as large as or slightly larger than the diameter of the molding insert as a whole. This enables an arrangement of nozzle 1 such that distal end wall 120 of nozzle housing 12 surrounds the molding insert to be cleaned. Nozzle abutment surface 123 of nozzle housing 12 serves for positioning nozzle 1 in the desired position relative to the molding insert and the molding surface to be cleaned.

Nozzle housing 12 further comprises a housing wall portion 122 that extends away from distal end wall 120 and surrounds longitudinally extending nozzle channel 10. This housing wall portion 122 of nozzle housing 12 generally comprises one to six, and more particularly may comprise one to four, in particular one, exhaust openings 125 arranged therein. Each of the exhaust openings 125 is circularly shaped and has a diameter 66 in the range of 10 millimeters to 60 millimeters, in particular 40 millimeters to 45 millimeters. In addition, the said housing wall portion 122 defines an exhaust channel 124 which is fluidically connected both to the gap 126 and to the exhaust openings 125. Exhaust channel 124 is arranged to circumferentially surround the (outer wall of) nozzle channel 10 and extends between the (inner wall of) the housing wall portion 122 and the (outer wall of) nozzle channel 10.

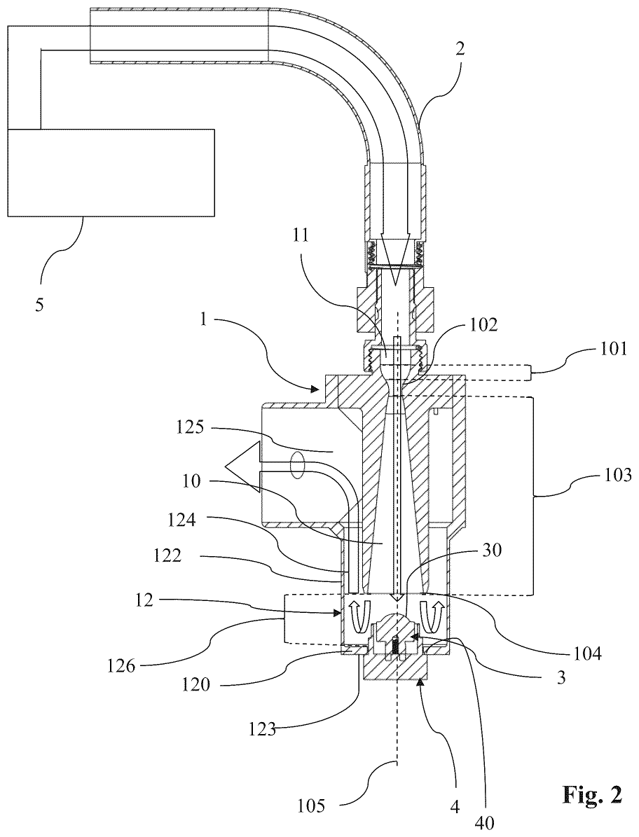

FIG. 2 shows a set-up where the convex molding surface 30 of a molding insert 3 is cleaned in accordance with a first embodiment of the method of the instant invention. Convex molding surface 30 of molding insert 3 is suitable for forming an optical surface (concave front surface) of a female lens mold. In an alternative embodiment, convex molding surface 30 of molding insert 3 may be suitable for forming a concave back surface of a male lens mold, the concave back surface of the male lens mold being located opposite to an optical surface (convex front surface) of the male lens mold. For cleaning molding insert 3 and in particular molding surface 30 thereof, molding insert 3 has been unmounted from a tooling plate and has been arranged on an insert holder 4 having a holder abutment surface 40. As can be seen, when mounted to insert holder 4 molding surface 30 of molding insert 3 faces away from insert holder 4 such that at least molding surface 30 of molding insert 3 is exposed.

Inlet 11 of nozzle 1 is fluidically connected to a dry ice machine 5 for the generation of dry ice particles via a tube 2. The generated dry ice particles have an average size in the range of 20 micrometers to 100 micrometers, in particular 40 micrometers to 80 micrometers. Dry ice machine 5 may be a commercially available dry ice machine, such as the dry ice machine ETS6 available from the company EisTec Trockeneistechnik GmbH, Stockstadt, Germany. The dry ice particles are mixed with a pressurized gas, in particular pressurized air (as carrier gas), and the dry ice particles together with the pressurized carrier gas are supplied to inlet 11 at a pressure in the range of 2 bars to 8 bars, in particular 4 bars to 6 bars, for a duration in a range of 10 seconds to 50 seconds, in particular 20 seconds to 40 seconds, and with a throughput of dry ice particles in a range of 1 gram to 3 grams per second. The dry ice particles contained in the carrier gas are supplied through inlet 11 into the nozzle channel 10 to form a jet of dry ice particles that exits nozzle channel 10 through outlet opening 104 (see straight arrow).

The nozzle abutment surface 123 and the holder abutment surface 40 are configured such that, when nozzle abutment surface 123 and holder abutment surface 40 abut against one another, nozzle 1 is positioned with outlet opening 104 of nozzle channel 10 facing molding surface 30 of molding insert 3 and being centered with respect to molding surface 30. Longitudinal channel axis 105 of nozzle channel 10 points towards molding surface 30 of the molding insert 3 and runs through the apex of convex molding surface 30. The diameter 64 of housing opening 121 defined by circumferentially running distal end wall 120 of nozzle housing 12 is larger than the diameter of molding insert 3, such that the distal end wall 120 of nozzle housing 12 surrounds molding insert 3 when nozzle abutment surface 123 and holder abutment surface 40 abut against one another. In this abutting arrangement, outlet opening 104 of nozzle channel 10 is arranged close to but above molding surface 30 of molding insert 3. In operation, once the dry ice particles contained in the jet of pressurized carrier gas are supplied to inlet 11 of nozzle 1 to form the jet of dry ice particles, this jet of dry ice particles then impinges on molding surface 30 of molding insert 3 and removes from molding surface 30 any residues of solid material used in injection-molding of single-use ophthalmic lens molds, such as polyolefin residues, for example polypropylene residues.

Exhausts of the jet of dry ice particles and of solid material removed from molding surface 30 of molding insert 3 are removed through exhaust channel 124 and exhaust openings 125 (see curved arrows). Each of the exhaust openings 125 has a diameter in the range of 10 millimeters to 60 millimeters, in particular 40 millimeters to 45 millimeters. Suction may be applied to the exhaust openings 125 to facilitate removal of the exhaust gases and solid material.

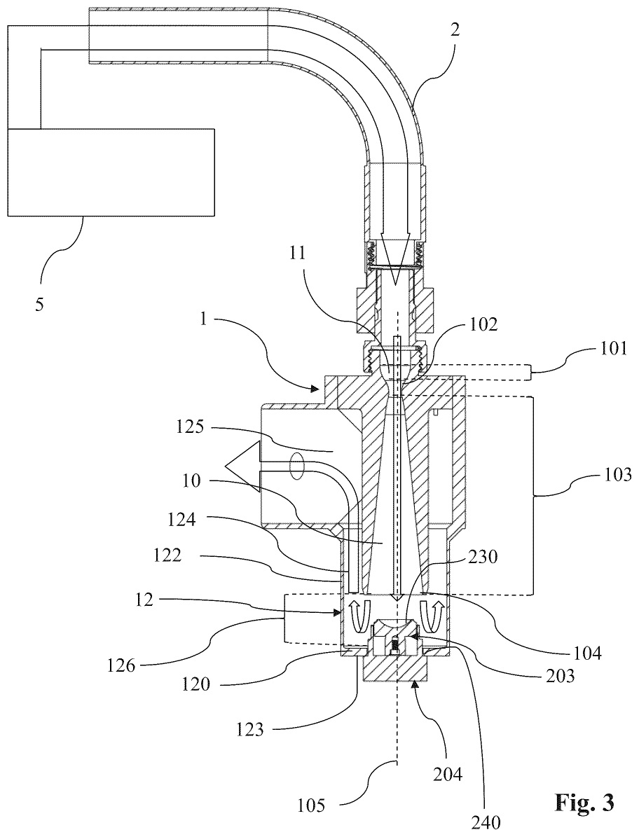

FIG. 3 shows a set-up where the concave molding surface 230 of a molding insert 203 is cleaned in accordance with a second embodiment of the method of the instant invention. Concave molding surface 230 of molding insert 203 is suitable for forming an optical surface (convex front surface) of a male lens mold. In an alternative embodiment, concave molding surface 230 of molding insert 203 may be suitable for forming a convex back surface of a female lens mold, the concave back surface of the female lens mold being located opposite to an optical surface (concave front surface) of the female lens mold. For cleaning molding insert 203 and in particular molding surface 230 thereof, molding insert 203 has been unmounted from a tooling plate and has been arranged on an insert holder 204 having a holder abutment surface 240. As can be seen, when mounted to insert holder 204 molding surface 230 of molding insert 203 faces away from insert holder 204 such that at least molding surface 230 of molding insert 203 is exposed.

Inlet 11 of nozzle 1 is fluidically connected to dry ice machine 5 for the generation of dry ice particles via a tube 2. The generated dry ice particles have an average size in the range of 20 micrometers to 100 micrometers, in particular 40 micrometers to 80 micrometers. Dry ice machine 5 may be a commercially available dry ice machine, such as the afore-mentioned the dry ice machine ETS6 available from the company EisTec Trockeneistechnik GmbH, Stockstadt, Germany. The dry ice particles are mixed with a pressurized gas, in particular pressurized air (as carrier gas), and the dry ice particles together with the pressurized carrier gas are supplied to inlet 11 at a pressure in the range of 2 bars to 8 bars, in particular 4 bars to 6 bars, for a duration in a range of 10 seconds to 50 seconds, in particular 20 seconds to 40 seconds, and with a throughput of dry ice particles in a range of 1 gram to 3 grams per second. The dry ice particles contained in the carrier gas are supplied through inlet 11 into the nozzle channel 10 to form a jet of dry ice particles that exits nozzle channel 10 through outlet opening 104 (see straight arrow).

The nozzle abutment surface 123 and the holder abutment surface 240 are configured such that, when the nozzle abutment surface 123 and the holder abutment surface 40 abut against one another, nozzle 1 is positioned with outlet opening 104 of nozzle channel 10 facing molding surface 230 of molding insert 203 and being centered with respect to molding surface 230. Longitudinal channel axis 105 of nozzle channel 10 points towards molding surface 230 of the molding insert 203 and runs through the lowermost point of concave molding surface 230. The diameter 64 of housing opening 121 defined by circumferentially running distal end wall 120 of nozzle housing 12 is larger than the diameter of molding insert 203, such that the distal end wall 120 of nozzle housing 12 surrounds molding insert 203 when nozzle abutment surface 123 and holder abutment surface 240 abut against one another. In this abutting arrangement, outlet opening 104 of nozzle channel 10 is arranged close to but above molding surface 230 of molding insert 203. In operation, once the dry ice particles contained in the jet of pressurized carrier gas are supplied to inlet 11 of nozzle 1 to form the jet of dry ice particles, this jet of dry ice particles then impinges on molding surface 230 of molding insert 203 and removes from molding surface 230 any residues of solid material used in injection-molding of single-use ophthalmic lens molds, such as polyolefin residues, for example polypropylene residues.

Exhausts of the jet of dry ice particles and of solid material removed from molding surface 230 of molding insert 203 are removed through exhaust channel 124 and exhaust openings 125 (see curved arrows). Each of the exhaust openings 125 has a diameter in the range of 10 millimeters to 60 millimeters, in particular 40 millimeters to 45 millimeters. Suction may be applied to the exhaust openings 125 to facilitate removal of the exhaust gases and solid material.

Embodiments of the method according to the invention have been describe above with the aid of the drawings. However, the invention is not limited to the embodiments described, as various changes are conceivable without departing from the teaching underlying the invention. Accordingly, the scope of protection is defined by the appended claims.

1. Method for cleaning a molding insert (3, 203) for injection-molding of single-use ophthalmic lens molds, comprising the steps of:
providing an insert holder (4, 204) comprising a holder abutment surface (40, 240),
arranging the molding insert (3, 203) on the insert holder (4, 204) such that a molding surface (30, 230) of the molding insert (3, 203) faces away from the insert holder (4, 204),
providing a dry ice nozzle (1) comprising
an inlet (11) for the supply of dry ice particles,
a nozzle channel (10) fluidically connected to the nozzle inlet (11), the nozzle channel (10) comprising a longitudinally extending inner wall portion (103) diverging towards and terminating at a distal end of the inner wall portion (103) in an outlet opening (104) of the nozzle channel (10), the diameter (61) of the outlet opening (104) of the nozzle channel (10) being at least as large as the diameter of the molding surface (30, 230) of the molding insert (3, 203), and
a nozzle housing (12) comprising
a circumferentially running distal end wall (120) comprising a nozzle abutment surface (123) which is arranged distally to the outlet opening (104) of the nozzle channel (10) to define a gap (126) between the distal end wall (120) and the outlet opening (104) of the nozzle channel (104), the distal end wall (120) defining a housing opening (121) having a diameter (64) which is at least as large as the diameter of the molding insert (3, 203), and
a housing wall portion (122) extending away from the distal end wall (120) and surrounding the longitudinally extending nozzle channel (10) to define an exhaust channel (124) which is fluidically connected to the gap (126) and to at least one exhaust opening (125) arranged in the housing wall portion (122) to allow for the removal of exhaust gas,
positioning the dry ice nozzle (1) on the insert holder (4, 204) such that the nozzle abutment surface (123) abuts against the holder abutment surface (40, 240),
supplying dry ice particles to the nozzle inlet (11) to generate a jet of dry ice particles impinging on the molding surface (30, 230) of the molding insert (3, 203) through the nozzle channel (10) and the outlet opening (104) of the nozzle channel (10), and
removing exhaust gases and any solid material removed from the molding surface (30, 230) of the molding insert (3, 203) through the exhaust channel (124) and the at least one exhaust opening (125) arranged in the housing wall portion (122) of the nozzle housing (12).

2. Method according to claim 1, wherein the nozzle channel (10) is rotationally symmetric with respect to a longitudinal channel axis (105) and has a diameter that increases from a diameter (60) in the range of 5 millimeters to 10 millimeters, in particular 6 millimeters to 8 millimeters, at a proximal end of the diverging inner wall portion to a diameter in the range of 19 millimeters to 25 millimeters, in particular 21 millimeters to 23 millimeters, at the distal end of the diverging inner wall portion (103) along a length (62) of the diverging inner wall portion in the range of 31 millimeters to 96 millimeters, in particular 50 millimeters to 70 millimeters.

3. Method according to claim 2, wherein the diverging inner wall portion (103) has an opening angle (63) in the range of 4 degrees to 15 degrees, in particular 4 degrees to 7.25 degrees, with respect to the longitudinal channel axis (105).

4. Method according to claim 1, wherein the gap (126) between the circumferentially running distal end wall (120) of the nozzle housing (12) and the outlet opening (104) of the nozzle channel (10) has a gap width (65) in the range of 7 millimeters to 15 millimeters, in particular 10 millimeters to 12 millimeters.

5. Method according to any one of claim 1, wherein the exhaust channel (124) circumferentially surrounds the longitudinally extending nozzle channel (10) between the nozzle channel (10) and the housing wall portion (122) of the nozzle housing (12) that extends away from the distal end wall (120).

6. Method according to claim 1, wherein the at least one exhaust opening (125) arranged in the housing wall portion (122) of the nozzle housing (12) comprises one to six, in particular one, exhaust openings (125) arranged in the housing wall portion (122), each of the exhaust openings (125) having a diameter (66) in the range of 10 millimeters to 60 millimeters, in particular 40 millimeters to 45 millimeters.

7. Method according to claim 1, wherein the nozzle channel (10) comprises a further longitudinally extending inner wall portion (101) which is fluidically connected to the nozzle inlet (11) and which converges from a proximal end thereof towards a throat (102) at a distal end thereof, with the diverging inner wall portion (103) of the nozzle channel (10) being fluidically connected to the throat (102).

8. Method according to claim 1, wherein the molding insert (3, 203) is a molding insert (3, 203) selected from a group of molding inserts having one of
a convex molding surface (30) for forming an optical surface of a female lens mold,
a concave molding surface (230) for forming an optical surface of a male lens mold,
a concave molding surface for forming a back surface of a female lens mold, the back surface of the female lens mold located opposite to an optical surface of the female lens mold, or
a convex molding surface to form a back surface of a male lens mold, the back surface of the male lens mold located opposite to an optical surface of the male lens mold.

9. Method according to claim 1, wherein the step of supplying dry ice particles to the nozzle inlet (11) comprises supplying dry ice particles having an average particle size in a range of 20 micrometers to 100 micrometers, in particular 40 micrometers to 80 micrometers, at a pressure in a range of 2 bars to 8 bars, in particular 4 bars to 6 bars, for a duration in a range of 10 seconds to 50 seconds, in particular 20 seconds to 40 seconds, and with a throughput of dry ice particles in a range of 1 gram to 3 grams per second.

10. Method according to claim 1, wherein the step of removing exhaust gases and any solid material removed from the molding surface (30, 230) of the molding insert (3, 203) comprises removing solid material used in injection-molding the single-use ophthalmic lens molds, in particular a polyolefin such as polypropylene.
